(19) United States
(12) Patent Application Publication
(10) Pub. No.: US 2008/0007810 A1
(43) Pub. Date: Jan. 10, 2008

(54) Optical Scanning Module of a Scanner

(76) Inventor: Ho-Kang Liu, Tai-Chung City (TW)

Correspondence Address: NORTH AMERICA INTELLECTUAL PROPERTY CORPORATION, P.O. BOX 506, MERRIFIELD, VA, 22116, US

(21) Appl. No.: 11/277,147

(22) Filed: Mar. 22, 2006

(30) Foreign Application Priority Data
Mar. 28, 2005 (TW) 094109549

(51) Int. Cl. G03B 27/00; G02B 26/08; H02N 6/00; H04N 1/04

(52) U.S. Cl. 359/196; 136/246; 359/197; 358/474; 355/57

(57) ABSTRACT

An optical scanning module includes a housing, four reflectors and a lens module. The housing has a right section and a left section. The four reflectors are positioned at the right section of the housing. The lens module is positioned at the left section. The arrangement of the lens module and the four reflectors allows more space to be saved so that a smaller and thinner scanner can be produced.

### BACKGROUND OF THE INVENTION

1. Field of the Invention

The present invention relates to an optical scanning module of a scanner, more particularly, an optical scanning module of a space saving scanner.

2. Description of the Prior Art

In order to comply with consumer's needs, most consumer electronic products are gradually heading towards development of miniature designs. Designers, other than utilizing smaller components in order to save space, are concentrating on arrangement of space between components. This effort to comply with consumer's needs has become one of the important factors in designing miniature products.

Please refer to FIG. 1. FIG. 1 illustrates a diagram of an optical scanning module 100 of a conventional scanner. The optical scanning module 100 comprises a light source 110, three reflectors 120, a lens module 130, and a light sensor 140. The reflectors 120 are utilized for reflecting light 160 after the light source 110 reflected from a document 150, the lens module 130 for focusing light 160 reflected from the reflectors 120, and light 160 is then transmitted to the light sensor 140 to detect an image of the document 150. As the lens module 130 is positioned in a section above the reflectors 120, therefore thickness of the optical scanning module 100 cannot decrease due to the position of the lens module 130. Please refer to FIG. 2. FIG. 2 illustrates an optical scanning module 200 of another conventional scanner. In order to decrease thickness of the optical scanning module 200, the prior art (please refer to U.S. Pat. No. 6,456,412) discloses the optical scanning module 200 wherein the lens module 130 is installed aside of a reflector 220. Installing the lens module 130 aside of the reflector 220 therefore provides the opportunity to reduce the thickness of the optical scanning module 200 of FIG. 2. The scanning module 200 of FIG. 2 is less thick than the optical scanning module 100 of FIG. 1.

Furthermore, according to the theory of light, the total length of light 160 from the document 150 to the light sensor 140 has to be equaled to focal length of the lens module 130. In another words, under the condition where the number of reflectors is constant, if the length of light between the reflectors can be increased, then the space occupied by the reflectors in the optical scanning module can be decreased. In addition, if the number of reflections of the reflectors increases, reflective points on the reflectors also increase, thus the reflector requires a larger reflective area, and hence space occupied by the reflectors is also increased. Therefore, if length of light between the reflectors can be increased with a minimum number of reflections, then thickness and volume of the optical scanning module can be further reduced.

As shown in FIG. 2, the reflectors 220, arranged in sequence for reflecting in alternate horizontal and vertical sequence, reflect light 160 from the document 150. Although the total reflection is only five times, as the thickness of the optical scanning module 200 becomes thinner, the vertical route of the light 160 becomes shorter, however, the height of the space occupied by the reflectors 220 has a minimum limit, therefore the thickness and volume of the optical scanning module cannot be further reduced.

### SUMMARY OF THE INVENTION

The main objective of the claimed invention is to provide an optical scanning module of a scanner to solve the above-mentioned problem of the conventional scanner.

The optical scanning module of the claimed invention comprises a housing having an opening, a light source installed aside of the opening for generating light to scan a document, a first reflector installed below the opening for reflecting light reflected from the document, a second reflector installed at an upper left side of the first reflector for reflecting light from the first reflector, a third reflector installed at an upper left side of the first reflector for reflecting light from the second reflector, a fourth reflector installed at a left side of the first reflector for reflecting light from the third reflector to the third reflector, a lens module installed at a left side of the four reflectors for focusing light reflected from the third reflector, and a light sensor installed at a left side of the lens module for sensing light transmitted from the lens module.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a diagram of an optical scanning module of a conventional scanner.

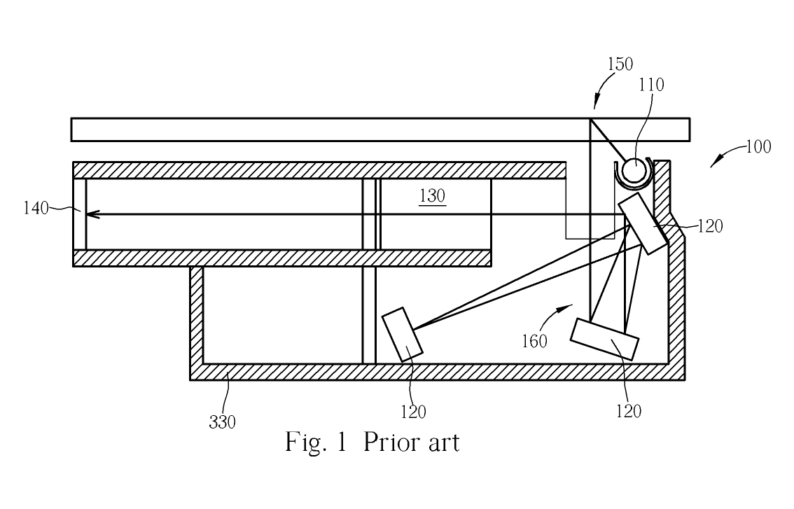

FIG. 2 illustrates an optical scanning module of a second conventional scanner.

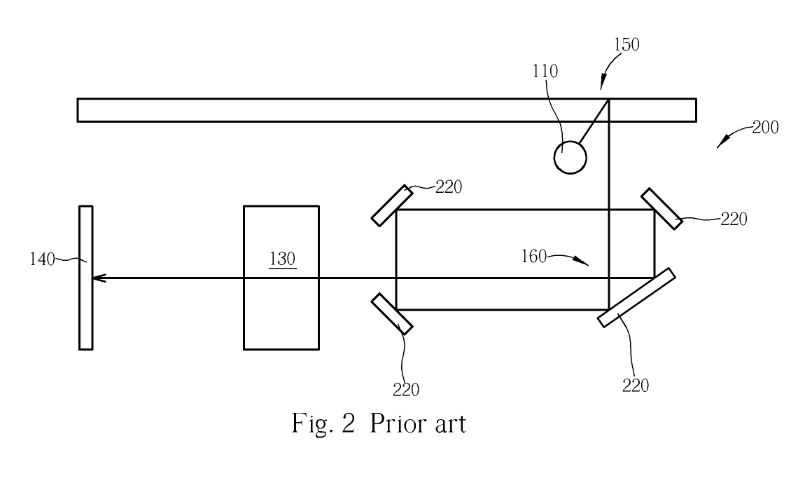

FIG. 3 illustrates a diagram of an optical scanning module according to the present invention.

### DETAILED DESCRIPTION

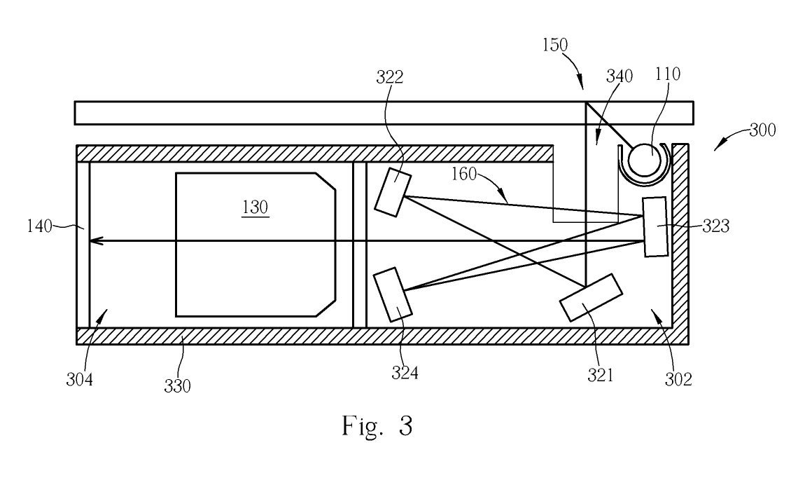

Please refer to FIG. 3. FIG. 3 illustrates a diagram of an optical scanning module 300 according to the present invention. The optical scanning module 300 comprises a light source 110, four reflectors 321-324, a lens module 130 and a light sensor 140. As shown in FIG. 3, the optical scanning module 300 is divided into 2 sections: a first section 302 and a second section 304. The first section 302 is located on right of the second section 304, and an opening 340 formed above the first section 302. As a result of the lens module 130 being installed within the second section 304, and the four reflectors 321-324 are placed surrounding the first section 302, thickness of the optical scanning module can be reduced.

In order to increase the length of light 160 between the four reflectors 321-324, the four reflectors 321-324 of the optical scanning module reflect light 160 to the diagonal reflectors 322-324 to maximize length of light 160 between the reflectors 321-324. As shown in FIG. 3, the first reflector 321, installed below the opening 340 of a housing 330, is utilized for reflecting light 160 reflected from the document; the second reflector 322 installed at an upper left side of the first reflector 321 (which is an upper left corner of the first section 302), is utilized for reflecting light 160 reflected from the first reflector 321; the third reflector 323 installed at an upper right side of the first reflector 321 (which is a right end of the first section 302), is utilized for reflecting light 160 reflected from the second reflector 322; the fourth reflector 324 installed at a left side of the first reflector 321 (which is a lower left corner of the first section 302), is utilized for reflecting light reflected from the third reflector 323 to the third reflector 323; the lens module 130, installed at a left side of the four reflectors 321-324 (which is a right end of the second section 304), is utilized for focusing light 160 reflected from the third reflector 323; and the light sensor 140 installed at a left side of the lens module 130 (which is a left end of the second section 304), is utilized for sensing light 160 transmitted from the lens module 130. In the above-mentioned reflections, length of light 160 between the four reflectors 321-324 will not be shorten due to a thinner optical scanning module 300, therefore height of the space occupied by the reflectors 321-324 can be lower than that of the prior art. Additionally, the length of the light 160 between the reflectors 321-324 is longer than that of the prior art. As a result, the thickness and volume of the optical scanning module 300 can be further reduced.

Furthermore, by installing the light source 110 at a right side of the opening 340 (which is an upper right corner of the first section 302), the effect of the light source 110 on light 160 can be reduced. For example, if the light source 110 is installed on a left side of the opening 340 and then when light 160 is reflected from the second reflector 322 to the third reflector 323, an interference with light 160 may be generated as the light source 110 protrudes at the housing 330. This arrangement will affect the quality of scanning images. In another words, if the light source 110 is installed at the left side of the opening 340, effectively preventing any interference, the position of the light source must be placed higher. In this way, the thickness of the optical scanning module will be increased. Therefore, the light source 110 installed on the right side of the opening 340 can further reduce thickness of the optical scanning module 300.

In comparison with the prior art, the arrangement of the lens module 130 and the four reflectors 321-324 of the optical scanning module 300 allows more space to be saved to produce a smaller and thinner scanner.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical scanning module of a scanner, the optical scanning module comprising:
a housing having an opening;
a light source installed aside of the opening for generating light for scanning a document;
a first reflector installed below the opening for reflecting light reflected from the document;
a second reflector installed at an upper left side of the first reflector for reflecting light reflected from the first reflector;
a third reflector installed at an upper right side of the first reflector for reflecting light reflected from the second reflector;
a fourth reflector installed at a left side of the first reflector for reflecting light reflected from the third reflector to the third reflector; and
a lens module installed at a left side of the four reflectors for focusing light reflected from the third reflector.

2. The optical scanning module of claim 1 wherein the light source is installed at a right side of the opening.

3. The optical scanning module of claim 1 further comprising a light sensor installed at a left side of the lens module for sensing light transmitted from the lens module.

4. An optical scanning module of a scanner, the optical scanning module comprising:
a housing comprising a first section, a second section formed at a left side of the first section, and an opening formed above the first section;
a light source installed within the first section for generating light for scanning a document;
a first reflector installed below the opening for reflecting light reflected from the document;
a second reflector installed at an upper left corner of the first section for reflecting light reflected from the first reflector;
a third reflector installed at a right end of the first section for reflecting light reflected from the second reflector;
a fourth reflector installed at a lower left corner of the first section for reflecting light reflected from the third reflector to the third reflector; and
a lens module installed within the second section for focusing light reflected from the third reflector.

5. The optical scanning module of claim 4 wherein the light source is installed at an upper right corner of the first section.

6. The optical scanning module of claim 4 further comprising a light sensor installed at a left side of the lens module for sensing light transmitted from the lens module.

7. The optical scanning module of claim 6 wherein the light sensor is installed at a left end of the second module.

8. The optical scanning module of claim 4 wherein the lens module is installed at a right end of the second section.
